(19) United States
(12) Patent Application Publication
(10) Pub. No.: US 2014/0132550 A1
(43) Pub. Date: May 15, 2014

(54) Electrical Contacts and Connectors

(71) Applicant: Microsoft Corporation, Redmond, WA (US)

(72) Inventors: Ivan Andrew McCracken, Sammamish, WA (US); Robyn Rebecca Reed McLaughlin, Seattle, WA (US); Anthony Ernest Hillyerd, Sammamish, WA (US); Summer L. Schneider, Portland, OR (US); Duane Martin Evans, Snohomish, WA (US); Yazan Aldehayyat, Seattle, WA (US); Brian David Bitz, Sherwood, OR (US); David Paul Platt, North Bend, WA (US); Gene Robert Obie, Clinton, WA (US)

(73) Assignee: Microsoft Corporation, Redmond, WA (US)

(21) Appl. No.: 14/162,529

(22) Filed: Jan. 23, 2014

Related U.S. Application Data
(63) Continuation-in-part of application No. 13/939,032, filed on Jul. 10, 2013.
Application No. 13/939,032 is a continuation of application No. 13/470,633, filed on May 14, 2012, now Pat. No. 8,498,100.
(60) Provisional application No. 61/758,581, filed on Jan. 30, 2013.
(60) Provisional application No. 61/606,313, filed on Mar. 2, 2012.

(51) Int. Cl. G06F 1/18

(52) U.S. Cl. CPC G06F 1/182
USPC 345/173

(57) ABSTRACT

Electrical contact and connector techniques are described. In one or more implementations, a computing system includes a computing device and an input device that are configured to be physically and communicatively coupled using a projection that is configured to be disposed within a channel, communication contacts that are configured to contact contacts within the channel to support the communicative coupling; and a protrusion disposed on the projection, the protrusion configured to be received within a cavity formed as part of the channel. The protrusion includes an electrical contact that is configured to be self-cleaning due to movement of the protrusion in relation to the cavity and is configured to transfer power between the input device and the computing device.

### RELATED APPLICATIONS

This application is a continuation-in-part of and claims priority to U.S. Provisional Application No. 61/758,581, titled “Power and Spine Connection”, filed Jan. 3, 2013 and to U.S. patent application Ser. No. 13/939,032, filed Jul. 10, 2013, and titled “Flexible Hinge and Removable Attachment” which is a continuation of and claims priority to U.S. patent application Ser. No. 13/470,633, filed May 14, 2012, and titled “Flexible Hinge and Removable Attachment” and further claims priority under 35 U.S.C. §119(e) to U.S. Provisional Patent Application No. 61/606,313, filed Mar. 2, 2012, Attorney Docket Number 336084.01, and titled “Functional Hinge.”

### BACKGROUND

Mobile computing devices have been developed to increase the functionality that is made available to users in a mobile setting. For example, a user may interact with a mobile phone, tablet computer, or other mobile computing device to check email, surf the web, compose texts, interact with applications, and so on. Because mobile computing devices are configured to be mobile, however, the devices may be difficult to interact with in certain situations, such as to support data entry intensive uses.

Accordingly, input devices have been developed to expand the functionality of the computing device, such as through use of supplemental keyboards, track pads, and so on. Conventional techniques to install and remove the input devices from the computing device, however, alternated between being difficult to remove but providing good protection or being relatively easy to remove but providing limited protection.

Further, the functionality available via these devices continues to expand such that significant amounts of power and/or data may be involved in transfer between the devices. However, conventional connections were typically limited in the amount of power that could be transferred between the devices, thereby limiting functionality supported by these devices.

### SUMMARY

Electrical contact and connector techniques are described. In one or more implementations, an input device includes an input portion configured to generate signals to be processed by a computing device and a connection portion attached to the input portion. The connection portion is configured to be communicatively coupled to the computing device to communicate the generated signals and physically coupled to the computing device.

The connection portion includes a projection that is configured to be disposed within a channel formed in a housing of the computing device and a protrusion disposed on the projection. The protrusion is configured to be received within a cavity formed as part of the channel. The protrusion includes an electrical contact that is configured to be self-cleaning due to movement of the protrusion in relation to the cavity and is configured to transfer power between the input device and the computing device.

In one or more implementations, a computing system includes a computing device and an input device that are configured to be physically and communicatively coupled using a projection that is configured to be disposed within a channel, communication contacts that are configured to contact contacts within the channel to support the communicative coupling, and a protrusion disposed on the projection, the protrusion configured to be received within a cavity formed as part of the channel. The protrusion includes an electrical contact that is configured to engage in a wiping motion when the protrusion is moved within the cavity and transfer power between the input device and the computing device.

In one or more implementations, a computing system includes a computing device and an input device that are configured to be physically and communicatively coupled using a projection that is configured to be disposed within a channel, communication contacts disposed on the projection that are configured to provide the communicative coupling with contacts within the channel, and an electrostatic discharge device configured to protect the communication contacts from an electrostatic discharge by providing a path from the projection to ground the electrostatic discharge.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ the techniques described herein.

FIG. 2 depicts an example implementation of an input device of FIG. 1 as showing a flexible hinge in greater detail.

FIG. 3 depicts an example orientation of the input device in relation to the computing device as covering a display device of the computing device.

FIG. 4 depicts an example orientation of the input device in relation to the computing device as assuming a typing orientation.

FIG. 5 depicts an example orientation of the input device in relation to the computing device as covering a rear housing of the computing device and exposing a display device of the computing device.

FIG. 6 depicts an example orientation of the input device as including a portion configured to cover a rear of the computing device, which in this instance is used to support a kickstand of the computing device.

FIG. 7 depicts an example orientation in which the input device including the portion of FIG. 6 are used to cover both the front and back of the computing device.

FIG. 8 depicts an example implementation showing a perspective view of a connection portion of FIG. 2 that includes mechanical coupling protrusions and a plurality of communication contacts.

FIG. 9 depicts a cross section taken along an axis showing a communication contact as well as a cross section of a cavity of the computing device in greater detail.

FIG. 10 depicts a cross section of the computing device, connection portion, and flexible hinge of the input device as being oriented as shown in FIG. 3 in which the input device acts as a cover for a display device of the computing device.

FIG. 11 depicts a cross section taken along an axis showing a magnetic coupling device as well as a cross section of the cavity of the computing device in greater detail.

FIG. 12 depicts an example of a magnetic coupling portion that may be employed by the input device or computing device to implement a flux fountain.

FIG. 13 depicts another example of a magnetic coupling portion that may be employed by the input device or computing device to implement a flux fountain.

FIG. 14 depicts a cross section taken along an axis showing a mechanical coupling protrusion as well as a cross section of the cavity of the computing device in greater detail.

FIG. 15 depicts a perspective view of a protrusion as configured to communicate signals and/or transmit power between the input device and the computing device.

FIG. 16 illustrates a top view of a protrusion in which a surface is divided to support a plurality of different contacts.

FIG. 17 depicts a cross section view of the protrusion of FIG. 16 as disposed within a cavity of the computing device.

FIG. 18 depicts an example implementation showing an exploded view of a self-cleaning electrical contact that is formed as part of a mechanical coupling protrusion.

FIG. 19 depicts an example implementation showing the mechanical coupling protrusion of FIG. 18 in an isometric cutaway view.

FIG. 20 depicts an example implementation showing a top view of one of the mechanical coupling protrusions and formed electrical contacts disposed thereon.

FIG. 21 depicts an example implementation shown via a cross section of a mechanical interlock feature supported by the mechanical coupling protrusion that includes an electrical connection between the input device and computing device.

FIG. 22 depicts an example implementation showing an isometric cutaway view to exhibit self-cleaning functionality of the electrical contacts due to movement in relation to each other.

FIG. 23 depicts an example implementation in which the input device and computing device are configured to support a non-arcing connection.

FIG. 24 depicts an exploded isometric view showing techniques of manufacturing assembly.

FIG. 25 depicts an example implementation showing the electrical contact of FIG. 24 in greater detail.

FIG. 26 depicts an example implementation in which the electrical contacts are formed to have a rounded shape.

FIGS. 27 and 28 depict example implementations of alternative design combinations in which the moveable electrical contacts are included on the computing device and non-moving electrical contacts are included on the input device.

FIGS. 29 and 30 depict example implementations of an electrostatic discharge device that is configured to protect communication contacts of a computing device.

FIGS. 31 and 32 include exploded views of components of the electrostatic discharge device.

FIG. 33 depicts an example implementation in which a connector utilized to support communication contacts of the computing device acts as a structural support.

FIG. 34 illustrates an example system including various components of an example device that can be implemented as any type of computing device as described with reference to FIGS. 1-33 to implement embodiments of the techniques described herein.

### DETAILED DESCRIPTION

Overview

A variety of different devices may be physically attached to a mobile computing device to provide a variety of functionality. For example, a device may be configured to provide a cover for at least a display device of the computing device to protect it against harm. Other devices may also be physically attached to the mobile computing device, such as an input device (e.g., keyboard having a track pad) to provide inputs to the computing device. Further, these devices may involve a transfer of power between the computing device and the device. However, conventional techniques that were utilized to support transfer of power could be limited in an amount of power supported, bulky and therefore have an effect on an overall form factor of the device and/or the computing device, and so forth.

Electrical contacts and connector techniques are described. In one or more implementations, an electrical contact that is configured to transfer power and/or data between an input device and a computing device is configured to support self-cleaning functionality. This may be implemented through use of a wiping movement that causes at least partial removal of an oxide layer on the electrical contact of the input device and/or the computing device.

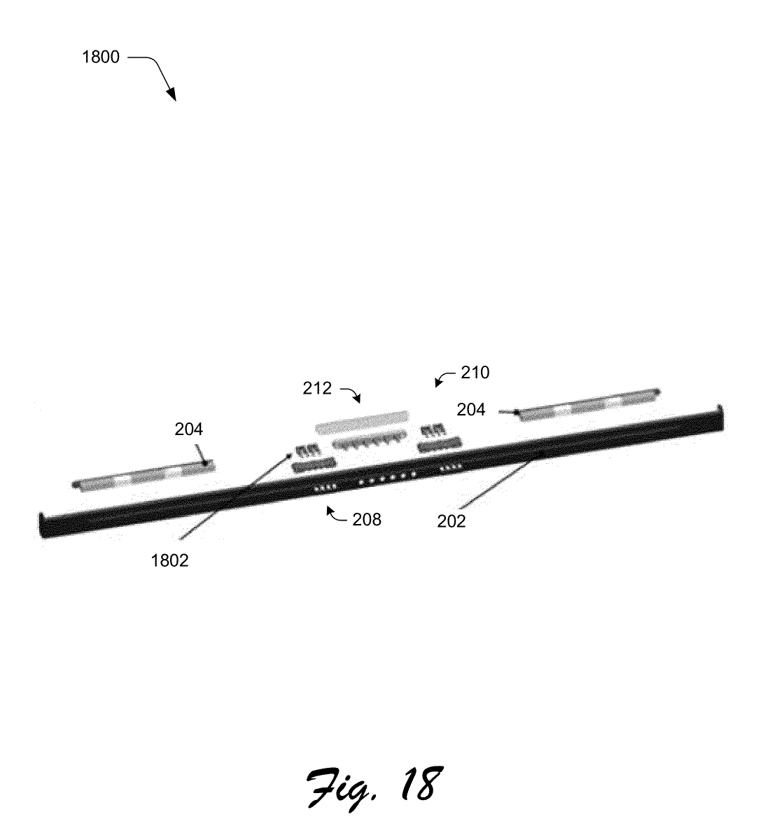

This wiping movement may be performed as part of attachment or removal of the input device to or from the computing device. In this way, a larger transfer of power and/or data may be supported between the computing device and the input device by physically reducing the resistance at the contact interface, as described in relation to FIG. 23. This may be utilized to support a variety of functionality, such as to transfer power to the input device to support functionality that consumes significant amounts of power (e.g., the charge the input device, support haptic feedback, a display device, and so on) as well as support transfer of power and/or data from the input device to the computing device, e.g., when the input device includes an auxiliary power source for the computing device. Further description of these configurations of electrical contacts may be found beginning in relation to FIG. 18.

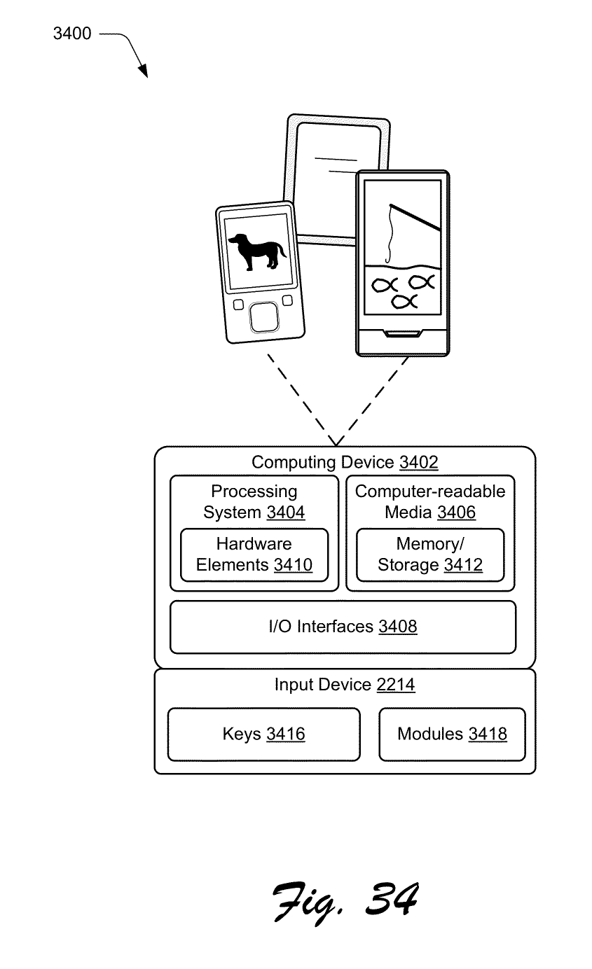

A variety of other functionality is also contemplated, such as to support an electrostatic discharge device that is configured to protect components of the computing device and/or input device from an electrostatic discharge, further discussion of which may be found in relation to FIGS. 29-32. In another example, a support used to guide communication contacts as part of a computing device may also be utilized as a support for a display device, further discussion of which may be found in relation to FIG. 33.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures. Further, although an input device is described, other devices are also contemplated that do not include input functionality, such as covers. For example, these techniques are equally applicable to passive devices, e.g., a cover having one or more materials (e.g., magnets, ferrous material, and so on) that are configured and positioned within the cover to be attracted to magnetic coupling devices of the computing device, use of protrusions and connecting portion, and so on as further described below.

Example Environment

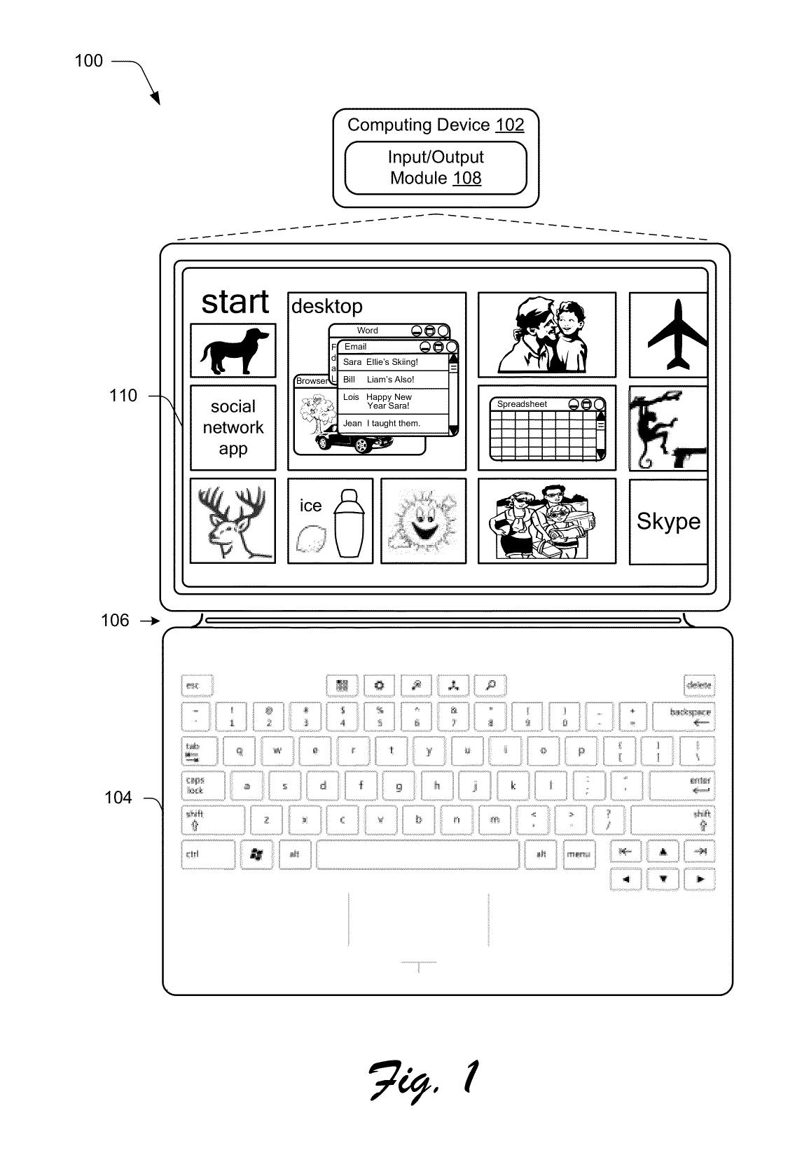

FIG. 1 is an illustration of an environment 100 in an example implementation that is operable to employ the techniques described herein. The illustrated environment 100 includes an example of a computing device 102 that is physically and communicatively coupled to an input device 104 via a flexible hinge 106. The computing device 102 may be configured in a variety of ways. For example, the computing device 102 may be configured for mobile use, such as a mobile phone, a tablet computer as illustrated, and so on. Thus, the computing device 102 may range from full resource devices with substantial memory and processor resources to a low-resource device with limited memory and/or processing resources. The computing device 102 may also relate to software that causes the computing device 102 to perform one or more operations.

The computing device 102, for instance, is illustrated as including an input/output module 108. The input/output module 108 is representative of functionality relating to processing of inputs and rendering outputs of the computing device 102. A variety of different inputs may be processed by the input/output module 108, such as inputs relating to functions that correspond to keys of the input device 104, keys of a virtual keyboard displayed by the display device 110 to identify gestures and cause operations to be performed that correspond to the gestures that may be recognized through the input device 104 and/or touchscreen functionality of the display device 110, and so forth. Thus, the input/output module 108 may support a variety of different input techniques by recognizing and leveraging a division between types of inputs including key presses, gestures, and so on.

In the illustrated example, the input device 104 is configured as having an input portion that includes a keyboard having a QWERTY arrangement of keys and track pad although other arrangements of keys are also contemplated. Further, other non-conventional configurations are also contemplated, such as a game controller, configuration to mimic a musical instrument, and so forth. Thus, the input device 104 and keys incorporated by the input device 104 may assume a variety of different configurations to support a variety of different functionality.

As previously described, the input device 104 is physically and communicatively coupled to the computing device 102 in this example through use of a flexible hinge 106. The flexible hinge 106 is flexible in that rotational movement supported by the hinge is achieved through flexing (e.g., bending) of the material forming the hinge as opposed to mechanical rotation as supported by a pin, although that embodiment is also contemplated. Further, this flexible rotation may be configured to support movement in one or more directions (e.g., vertically in the figure) yet restrict movement in other directions, such as lateral movement of the input device 104 in relation to the computing device 102. This may be used to support consistent alignment of the input device 104 in relation to the computing device 102, such as to align sensors used to change power states, application states, and so on.

The flexible hinge 106, for instance, may be formed using one or more layers of fabric and include conductors formed as flexible traces to communicatively couple the input device 104 to the computing device 102 and vice versa. This communication, for instance, may be used to communicate a result of a key press to the computing device 102, receive power from the computing device, perform authentication, provide supplemental power to the computing device 102, and so on. The flexible hinge 106 may be configured in a variety of ways, further discussion of which may be found in relation to the following figure.

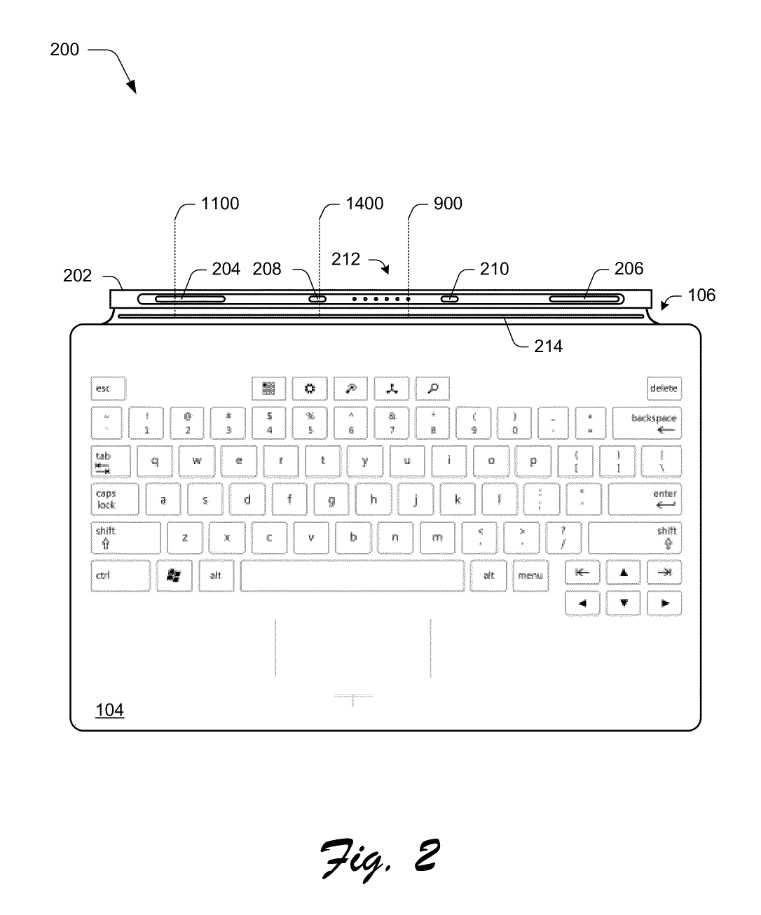

FIG. 2 depicts an example implementation 200 of the input device 104 of FIG. 1 as showing the flexible hinge 106 in greater detail. In this example, a connection portion 202 of the input device is shown that is configured to provide a communicative and physical connection between the input device 104 and the computing device 102. The connection portion 202 as illustrated has a height and cross section configured to be received in a channel in the housing of the computing device 102, although this arrangement may also be reversed without departing from the spirit and scope thereof.

The connection portion 202 is flexibly connected to a portion of the input device 104 that includes the keys through use of the flexible hinge 106. Thus, when the connection portion 202 is physically connected to the computing device the combination of the connection portion 202 and the flexible hinge 106 supports movement of the input device 104 in relation to the computing device 102 that is similar to a hinge of a book.

Through this rotational movement, a variety of different orientations of the input device 104 in relation to the computing device 102 may be supported. For example, rotational movement may be supported by the flexible hinge 106 such that the input device 104 may be placed against the display device 110 of the computing device 102 and thereby act as a cover as shown in the example orientation 300 of FIG. 3. Thus, the input device 104 may act to protect the display device 110 of the computing device 102 from harm.

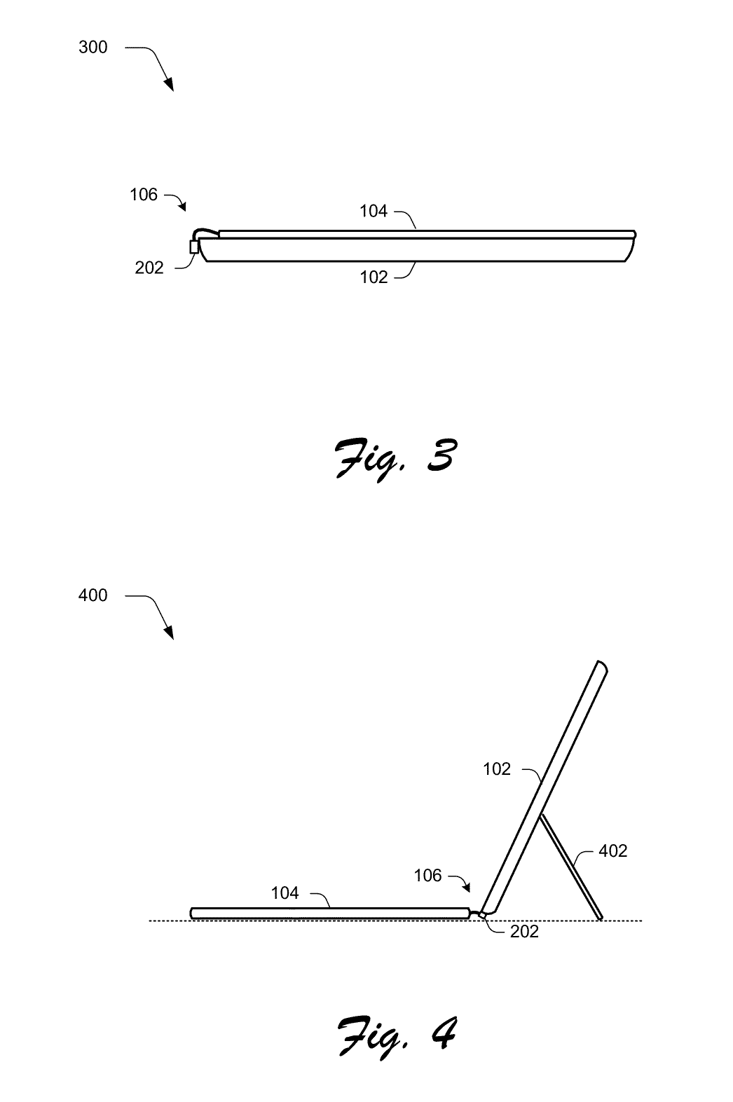

As shown in the example orientation 400 of FIG. 4, a typing arrangement may be supported. In this orientation, the input device 104 is laid flat against a surface and the computing device 102 is disposed at an angle to permit viewing of the display device 110, e.g., such as through use of a kickstand 402 disposed on a rear surface of the computing device 102.

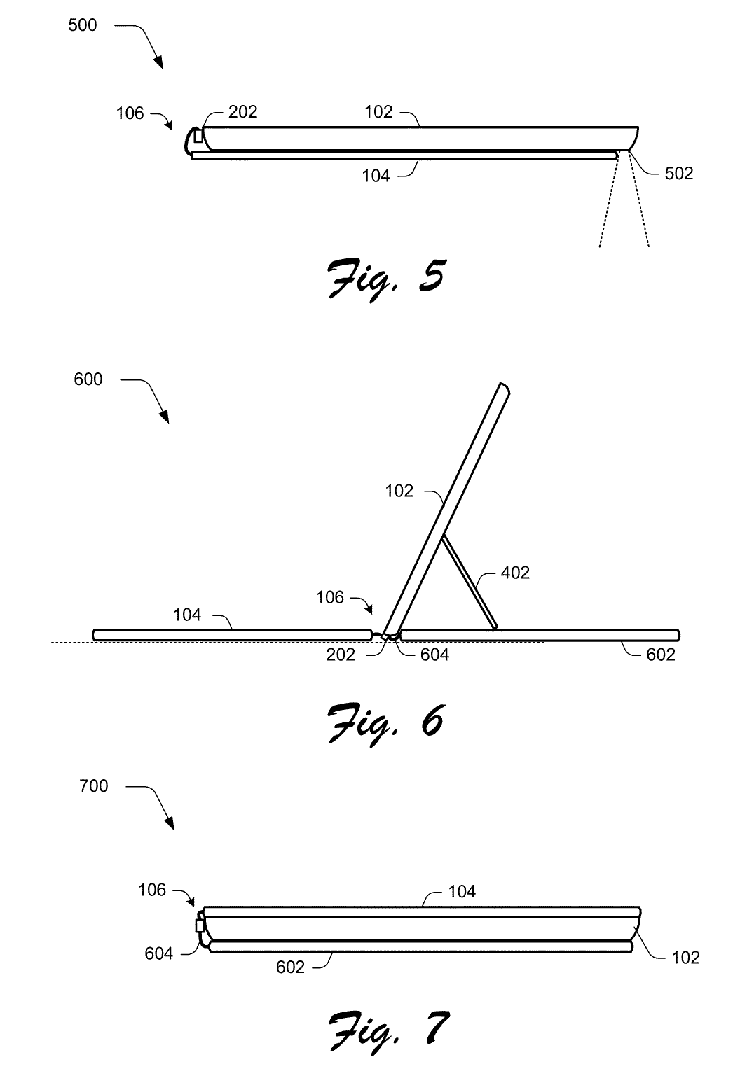

In the example orientation 500 of FIG. 5, the input device 104 may also be rotated so as to be disposed against a back of the computing device 102, e.g., against a rear housing of the computing device 102 that is disposed opposite the display device 110 on the computing device 102. In this example, through orientation of the connection portion 202 to the computing device 102, the flexible hinge 106 is caused to “wrap around” the connection portion 202 to position the input device 104 at the rear of the computing device 102.

This wrapping causes a portion of a rear of the computing device 102 to remain exposed. This may be leveraged for a variety of functionality, such as to permit a camera 502 positioned on the rear of the computing device 102 to be used even though a significant portion of the rear of the computing device 102 is covered by the input device 104 in this example orientation 500. Although configuration of the input device 104 to cover a single side of the computing device 102 at any one time was described above, other configurations are also contemplated.

In the example orientation 600 of FIG. 6, the input device 104 is illustrated as including a portion 602 configured to cover a rear of the computing device. This portion 602 is also connected to the connection portion 202 using a flexible hinge 604.

The example orientation 600 of FIG. 6 also illustrates a typing arrangement in which the input device 104 is laid flat against a surface and the computing device 102 is disposed at an angle to permit viewing of the display device 110. This is supported through use of a kickstand 402 disposed on a rear surface of the computing device 102 to contact the portion 602 in this example.

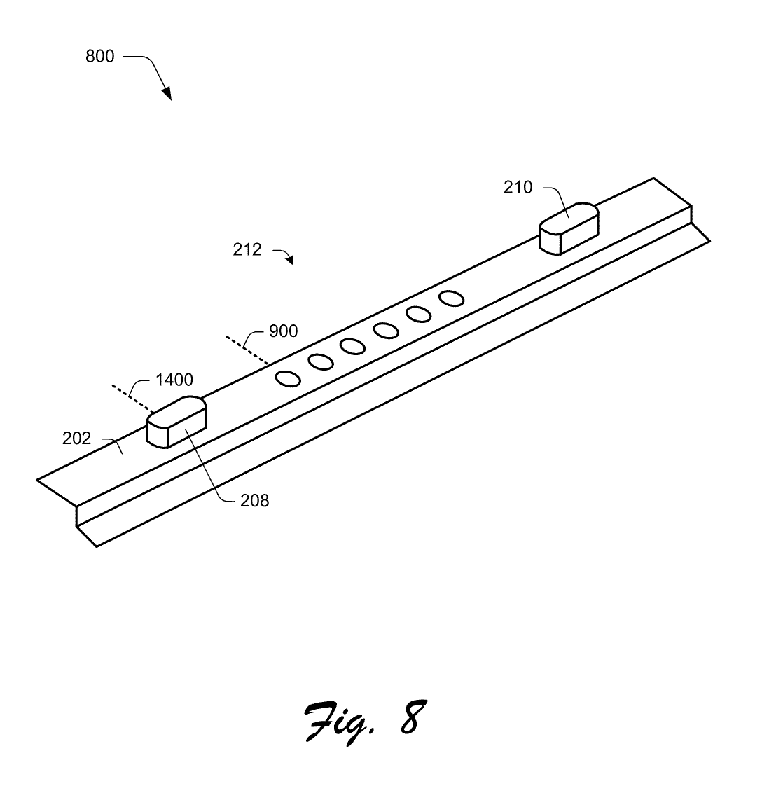

FIG. 7 depicts an example orientation 700 in which the input device 104 including the portion 602 are used to cover both the front (e.g., display device 110) and back (e.g., opposing side of the housing from the display device) of the computing device 102. In one or more implementations, electrical and other connectors may also be disposed along the sides of the computing device 102 and/or the input device 104, e.g., to provide auxiliary power when closed.

Naturally, a variety of other orientations are also supported. For instance, the computing device 102 and input device 104 may assume an arrangement such that both are laid flat against a surface as shown in FIG. 1. Other instances are also contemplated, such as a tripod arrangement, meeting arrangement, presentation arrangement, and so forth.

Returning again to FIG. 2, the connection portion 202 is illustrated in this example as including magnetic coupling devices 204, 206, mechanical coupling protrusions 208, 210, and a plurality of communication contacts 212. The magnetic coupling devices 204, 206 are configured to magnetically couple to complementary magnetic coupling devices of the computing device 102 through use of one or more magnets. In this way, the input device 104 may be physically secured to the computing device 102 through use of magnetic attraction.

The connection portion 202 also includes mechanical coupling protrusions 208, 210 to form a mechanical physical connection between the input device 104 and the computing device 102. The mechanical coupling protrusions 208, 210 are shown in greater detail in relation to FIG. 8, which is discussed below. Additionally, the protrusions 208, 210 may be configured to support communication of data and/or transfer of power, further discussion of which may be found beginning in relation to FIG. 18.

FIG. 8 depicts an example implementation 800 showing a perspective view of the connection portion 202 of FIG. 2 that includes the mechanical coupling protrusions 208, 210 and the plurality of communication contacts 212. As illustrated, the mechanical coupling protrusions 208, 210 are configured to extend away from a surface of the connection portion 202, which in this case is perpendicular although other angles are also contemplated.

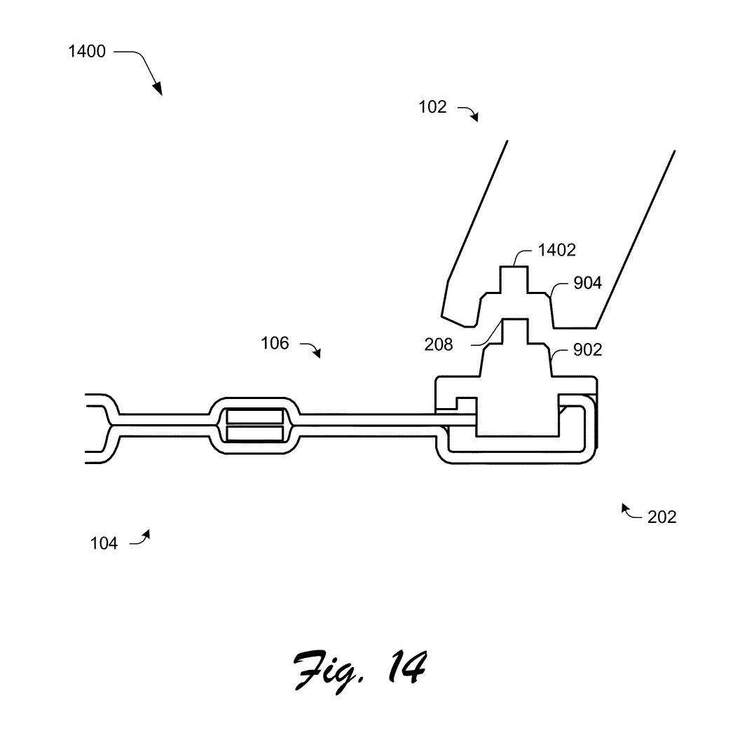

The mechanical coupling protrusions 208, 210 are configured to be received within complimentary cavities within the channel of the computing device 102. When so received, the mechanical coupling protrusions 208, 210 promote a mechanical binding between the devices when forces are applied that are not aligned with an axis that is defined as correspond to the height of the protrusions and the depth of the cavity, further discussion of which may be found in relation to FIG. 14

The connection portion 202 is also illustrated as including a plurality of communication contacts 212. The plurality of communication contacts 212 is configured to contact corresponding communication contacts of the computing device 102 to form a communicative coupling between the devices as shown and discussed in greater detail in relation to the following figure.

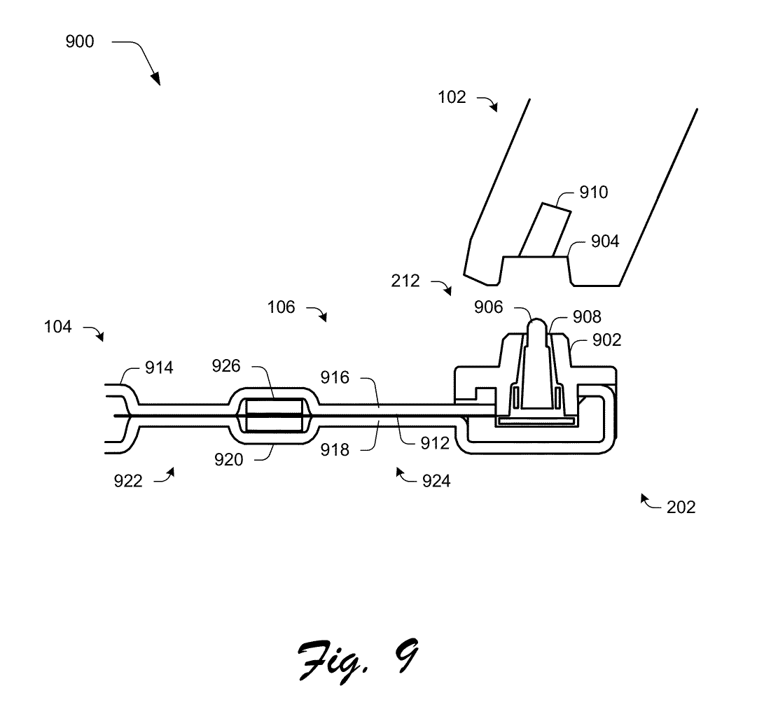

FIG. 9 depicts a cross section taken along an axis 900 of FIGS. 2 and 8 showing one of the communication contacts 212 as well as a cross section of a cavity of the computing device 102 in greater detail. The connection portion 202 is illustrated as including a projection 902 that is configured to be complimentary to a channel 904 of the computing device 102, e.g., having complimentary shapes, such that movement of the projection 902 within the cavity 904 is limited.

The communication contacts 212 may be configured in a variety of ways. In the illustrated example, the communication contact 212 of the connection portion 202 is formed as a spring loaded pin 906 that is captured within a barrel 908 of the connection portion 202. The spring loaded pin 906 is biased outward from the barrel 908 to provide a consistent communication contact between the input device 104 and the computing device 102, such as to a contact 910 of the computing device 102. Therefore, contact and therefore communication may be maintained during movement or jostling of the devices. A variety of other examples are also contemplated, including placement of the pins on the computing device 102 and contacts on the input device 104.

The flexible hinge 106 is also shown in greater detail in the example of FIG. 9. The flexible hinge 106 in this cross section includes a conductor 912 that is configured to communicatively coupled the communication contact 212 of the connection portion 202 with an input portion 914 of the input device 104, e.g., one or more keys, a track pad, and so forth. The conductor 912 may be formed in a variety of ways, such as a copper trace that has an operational flexibility to permit operation as part of the flexible hinge, e.g., to support repeated flexing of the hinge 106. Flexibility of the conductor 912, however, may be limited, e.g., may remain operational to conduct signals for flexing that is performed above a minimum bend radius.

Accordingly, the flexible hinge 106 may be configured to support a minimum bend radius based on the operational flexibility of the conductor 912 such that the flexible hinge 106 resists flexing below that radius. A variety of different techniques may be employed. The flexible hinge 106, for instance, may be configured to include first and second outer layers 916, 918, which may be formed from a fabric, microfiber cloth, and so on. Flexibility of material used to form the first and/or second outer layers 916, 918 may be configured to support flexibility as described above such that the conductor 912 is not broken or otherwise rendered inoperable during movement of the input portion 914 in relation to the connection portion 202.

In another instance, the flexible hinge 106 may include a mid-spine 920 located between the connection portion 202 and the input portion 914. The mid-spine 920, for example, includes a first flexible portion 922 that flexible connects the input portion 904 to the mid-spine 920 and a second flexible portion 924 that flexible connects the mid-spine 920 to the connection portion 920.

In the illustrated example, the first and second outer layers 916, 918 extend from the input portion 914 (and act as a cover thereof) through the first and second flexible portions 922, 924 of the flexible hinge 106 and are secured to the connection portion 202, e.g., via clamping, adhesive, and so on. The conductor 912 is disposed between the first and second outer layers 916, 918. The mid-spine 920 may be configured to provide mechanical stiffness to a particular location of the flexible hinge 106 to support a desired minimum bend radius, further discussion of which may be found in relation to the following figure.

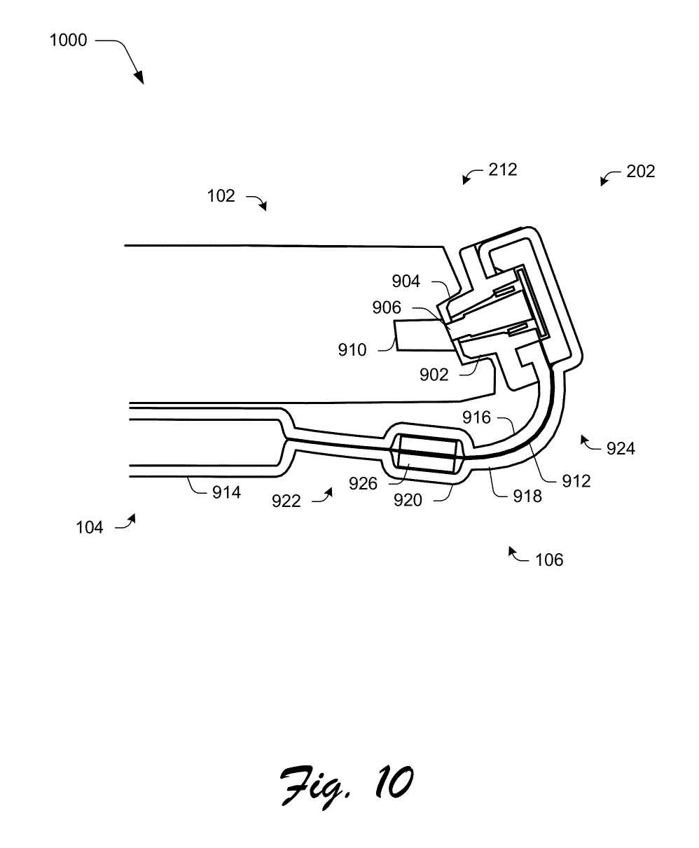

FIG. 10 depicts a cross section of the computing device 102, connection portion 202 and flexible hinge 106 of the input device 104 as being oriented as shown in FIG. 3 in which the input device 104 acts as a cover for a display device 110 of the computing device 102. As illustrated, this orientation causes the flexible hinge 106 to bend. Through inclusion of the mid-spine 920 and sizing of the first and second flexible portions 922, 924, however, the bend does not exceed an operational bend radius of the conductor 912 as previously described. In this way, the mechanical stiffness provided by the mid-spine 920 (which is greater than a mechanical stiffness of other portions of the flexible hinge 106) may protect the conductors 912.

The mid-spine 920 may also be used to support a variety of other functionality. For example, the mid-spine 920 may support movement along a longitudinal axis as shown in FIG. 1 yet help restrict movement along a latitudinal axis that otherwise may be encountered due to the flexibility of the flexible hinge 106.

Other techniques may also be leveraged to provide desired flexibility at particular points along the flexible hinge 106. For example, embossing may be used in which an embossed area, e.g., an area that mimics a size and orientation of the mid-spine 920, is configured to increase flexibility of a material, such as one or more of the first and second outer layers 916, 918, at locations that are embossed. An example of an embossed line 214 that increases flexibility of a material along a particular axis is shown in FIG. 2. It should be readily apparent, however, that a wide variety of shapes, depths, and orientations of an embossed area are also contemplated to provide desired flexibility of the flexible hinge 106.

FIG. 11 depicts a cross section taken along an axis 1100 of FIGS. 2 and 8 showing the magnetic coupling device 204 as well as a cross section of the cavity 904 of the computing device 102 in greater detail. In this example, a magnet of the magnetic coupling device 204 is illustrated as disposed within the connection portion 202.

Movement of the connection portion 202 and the channel 904 together may cause the magnet 1102 to be attracted to a magnet 1104 of a magnetic coupling device 1106 of the computing device 102, which in this example is disposed within the channel 904 of a housing of the computing device 102. In one or more implementations, flexibility of the flexible hinge 106 may cause the connection portion 202 to “snap into” the channel 904. Further, this may also cause the connection portion 202 to “line up” with the channel 904, such that the mechanical coupling protrusion 208 is aligned for insertion into the cavity 1002 and the communication contacts 208 are aligned with respective contacts 910 in the channel.

The magnetic coupling devices 204, 1106 may be configured in a variety of ways. For example, the magnetic coupling device 204 may employ a backing 1108 (e.g., such as steel) to cause a magnetic field generated by the magnet 1102 to extend outward away from the backing 1108. Thus, a range of the magnetic field generated by the magnet 1102 may be extended. A variety of other configurations may also be employed by the magnetic coupling device 204, 1106, examples of which are described and shown in relation to the following referenced figure.

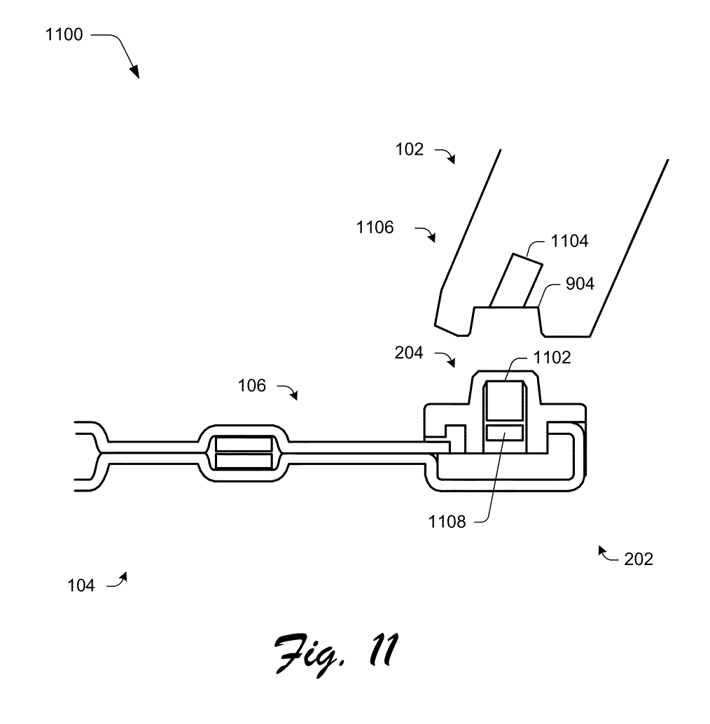

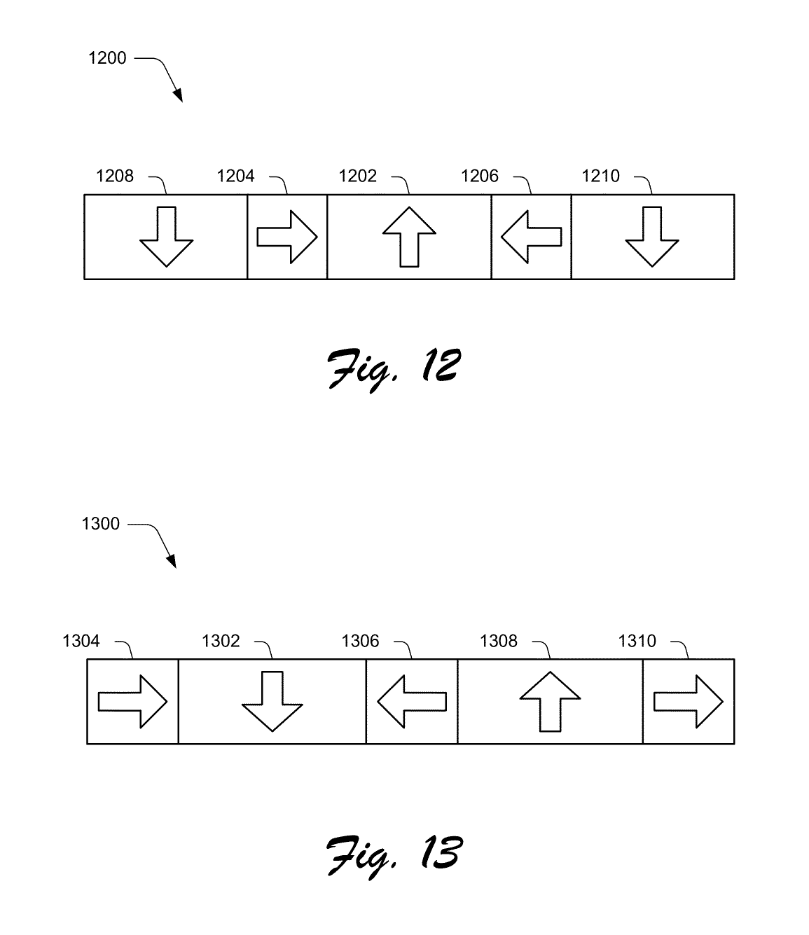

FIG. 12 depicts an example 1200 of a magnetic coupling portion that may be employed by the input device 104 or computing device 102 to implement a flux fountain. In this example, alignment of a magnet field is indicted for each of a plurality of magnets using arrows.

A first magnet 1202 is disposed in the magnetic coupling device having a magnetic field aligned along an axis. Second and third magnets 1204, 1206 are disposed on opposing sides of the first magnet 1202. The alignment of the respective magnetic fields of the second and third magnets 1204, 1206 is substantially perpendicular to the axis of the first magnet 1202 and generally opposed each other.

In this case, the magnetic fields of the second and third magnets are aimed towards the first magnet 1202. This causes the magnetic field of the first magnet 1202 to extend further along the indicated axis, thereby increasing a range of the magnetic field of the first magnet 1202.

The effect may be further extended using fourth and fifth magnets 1208, 1210. In this example, the fourth and fifth magnets 1208, 1210 have magnetic fields that are aligned as substantially opposite to the magnetic field of the first magnet 1202. Further, the second magnet 1204 is disposed between the fourth magnet 1208 and the first magnet 1202. The third magnet 1206 is disposed between the first magnet 1202 and the fifth magnet 1210. Thus, the magnetic fields of the fourth and fifth magnets 1208, 1210 may also be caused to extend further along their respective axes which may further increase the strength of these magnets as well as other magnets in the collection. This arrangement of five magnets is suitable to form a flux fountain. Although five magnets were described, any odd number of magnets of five and greater may repeat this relationship to form flux fountains of even greater strength.

To magnetically attach to another magnetic coupling device, a similar arrangement of magnets may be disposed “on top” or “below” of the illustrated arrangement, e.g., so the magnetic fields of the first, fourth and fifth magnets 1202, 1208, 1210 are aligned with corresponding magnets above or below those magnets. Further, in the illustrated example, the strength of the first, fourth, and fifth magnets 1202, 1208, 1210 is stronger than the second and third magnets 1204, 1206, although other implementations are also contemplated. Another example of a flux fountain is described in relation to the following discussion of the figure.

FIG. 13 depicts an example 1300 of a magnetic coupling portion that may be employed by the input device 104 or computing device 102 to implement a flux fountain. In this example, alignment of a magnet field is also indicted for each of a plurality of magnets using arrows.

Like the example 1200 of FIG. 12, a first magnet 1302 is disposed in the magnetic coupling device having a magnetic field aligned along an axis. Second and third magnets 1304, 1306 are disposed on opposing sides of the first magnet 1302. The alignment of the magnetic fields of the second and third magnets 1304, 1306 are substantially perpendicular the axis of the first magnet 1302 and generally opposed each other like the example 1200 of FIG. 12.

In this case, the magnetic fields of the second and third magnets are aimed towards the first magnet 1302. This causes the magnetic field of the first magnet 1302 to extend further along the indicated axis, thereby increasing a range of the magnetic field of the first magnet 1302.

This effect may be further extended using fourth and fifth magnets 1308, 1310. In this example, the fourth magnet 1308 has a magnetic field that is aligned as substantially opposite to the magnetic field of the first magnet 1302. The fifth magnet 1310 has a magnetic field that is aligned as substantially corresponding to the magnet field of the second magnet 1304 and is substantially opposite to the magnetic field of the third magnet 1306. The fourth magnet 1308 is disposed between the third and fifth magnets 1306, 1310 in the magnetic coupling device.

This arrangement of five magnets is suitable to form a flux fountain. Although five magnets are described, any odd number of magnets of five and greater may repeat this relationship to form flux fountains of even greater strength. Thus, the magnetic fields of the first 1302 and fourth magnet 1308 may also be caused to extend further along its axis which may further increase the strength of this magnet.

To magnetically attach to another magnetic coupling device, a similar arrangement of magnets may be disposed “on top” or “below” of the illustrated arrangement, e.g., so the magnetic fields of the first and fourth magnets 1302, 1308 are aligned with corresponding magnets above or below those magnets. Further, in the illustrated example, the strength of the first and fourth magnets 1302, 1308 (individually) is stronger than a strength of the second, third and fifth magnets 1304, 1306, 1310, although other implementations are also contemplated.

Further, the example 1200 of FIG. 12, using similar sizes of magnets, may have increased magnetic coupling as opposed to the example 1300 of FIG. 13. For instance, the example 1200 of FIG. 12 uses three magnets (e.g. the first, fourth, and fifth magnets 1202, 1208, 1210) to primarily provide the magnetic coupling, with two magnets used to “steer” the magnetic fields of those magnets, e.g., the second and third magnets 1204, 1206. However, the example 1300 of FIG. 13 uses two magnets (e.g., the first and fourth magnets 1302, 1308) to primarily provide the magnetic coupling, with three magnets used to “steer” the magnetic fields of those magnets, e.g., the second, third, and fifth magnets 1304, 1306, 1308.

Accordingly, though, the example 1300 of FIG. 13, using similar sizes of magnets, may have increased magnetic alignment capabilities as opposed to the example 1200 of FIG. 12. For instance, the example 1300 of FIG. 13 uses three magnets (e.g. the second, third, and fifth magnets 1304, 1306, 1310) to “steer” the magnetic fields of the first and fourth magnets 1302, 1308, which are used to provide primary magnetic coupling. Therefore, the alignment of the fields of the magnets in the example 1300 of FIG. 13 may be closer than the alignment of the example 1200 of FIG. 12.

Regardless of the technique employed, it should be readily apparent that the “steering” or “aiming” of the magnetic fields described may be used to increase an effective range of the magnets, e.g., in comparison with the use of the magnets having similar strengths by themselves in a conventional aligned state. In one or more implementations, this causes an increase from a few millimeters using an amount of magnetic material to a few centimeters using the same amount of magnetic material.

FIG. 14 depicts a cross section taken along an axis 1400 of FIGS. 2 and 8 showing the mechanical coupling protrusion 208 as well as a cross section of the cavity 904 of the computing device 102 in greater detail. As before, the projection 902 and channel 904 are configured to have complementary sizes and shapes to limit movement of the connection portion 202 with respect to the computing device 102.

In this example, the projection 902 of the connection portion 202 also includes disposed thereon the mechanical coupling protrusion 208 that is configured to be received in a complementary cavity 1402 disposed within the channel 904. The cavity 1402, for instance, may be configured to receive the protrusion 1002 when configured as a substantially oval post as shown in FIG. 8, although other examples are also contemplated.

When a force is applied that coincides with a longitudinal axis that follows the height of the mechanical coupling protrusion 208 and the depth of the cavity 1002, a user overcomes the magnetic coupling force applied by the magnets solely to separate the input device 104 from the computing device 102. However, when a force is applied along another axis (i.e., at other angles) the mechanical coupling protrusion 208 is configured to mechanically bind within the cavity 1002. This creates a mechanical force to resist removal of the input device 104 from the computing device 102 in addition to the magnetic force of the magnetic coupling devices 204, 206.

In this way, the mechanical coupling protrusion 208 may bias the removal of the input device 104 from the computing device 102 to mimic tearing a page from a book and restrict other attempts to separate the devices. Referring again to FIG. 1, a user may grasp the input device 104 with one hand and the computing device 102 with another and pull the devices generally away from each other while in this relatively “flat” orientation, e.g., to mimic ripping a page from a book. Through bending of the flexible hinge 106 the protrusion 208 and an axis of the cavity 1402 may be generally aligned to permit removal.

However, at other orientations, such as those shown in FIGS. 3-7, sides of the protrusion 208 may bind against sides of the cavity 1402, thereby restricting removal and promoting a secure connection between the devices. The protrusion 208 and cavity 1402 may be oriented in relation to each other in a variety of other ways as described to promote removal along a desired axis and promote a secure connection along other axes without departing from the spirit and scope thereof. The protrusion 208 may also be leveraged to provide a variety of other functionality besides mechanical retention, examples of which are discussed in relation to the following figures.

FIG. 15 depicts a perspective view 1500 of the protrusion as configured to communicate signals and/or transmit power between the input device 104 and the computing device 102. In this example, a top surface 1502 of the protrusion is configured to communicatively connect with a contact disposed within a cavity 1402 of the computing device 1402, or vice versa.

This contact may be used for a variety of purposes, such as to transmit power from the computing device 102 to the input device 104, from auxiliary power of the input device 104 to the computing device, communicate signals (e.g., signals generated from the keys of the keyboard), and so forth. Further, as shown in the top view 1600 of FIG. 16, the surface 1502 may be divided to support a plurality of different contacts, such as first and second contacts 1602, 1604 although other numbers, shapes, and sizes are also contemplated.

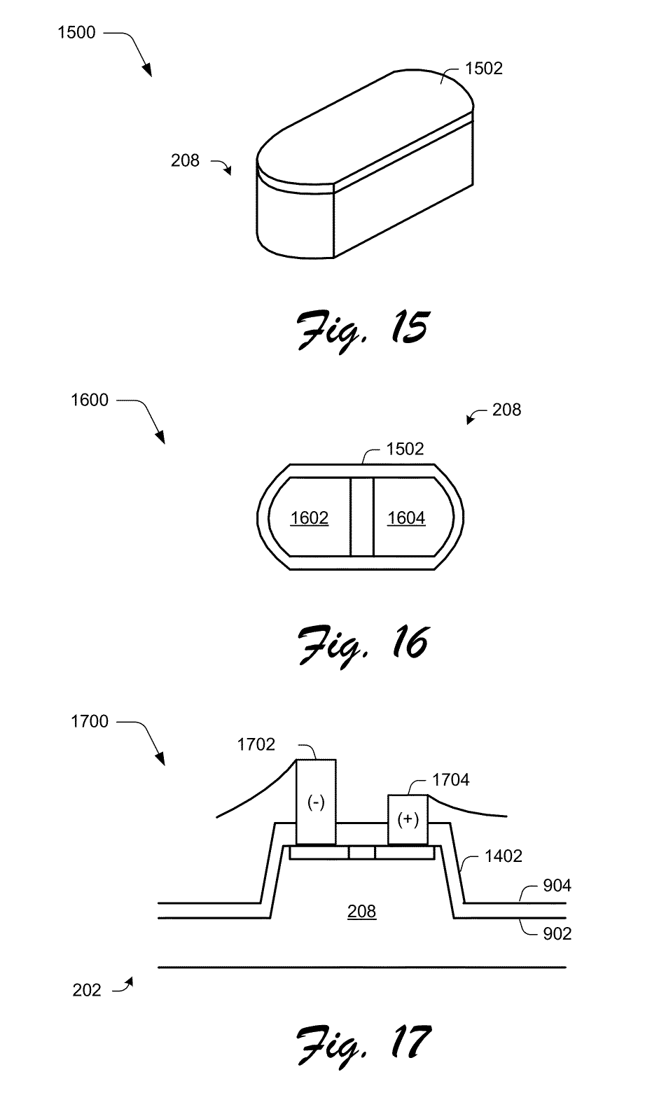

FIG. 17 depicts a cross section view 1700 of the protrusion 208 of FIG. 16 as disposed within the cavity 1402 of the computing device 102. In this example, first and second contacts 1702, 1704 include spring features to bias the contacts outward from the cavity 1402. The first and second contacts 1702, 1704 are configured to contact the first and second contacts 1602, 1602 of the protrusion, respectively. Further, the first contact 1702 is configured as a ground that is configured to contact the first contact 1602 of the protrusion 208 before the second contact 1704 touches the second contact 1604 of the protrusion 208. In this way, the input device 104 and the computing device 102 may be protected against electrical shorts. A variety of other examples are also contemplated without departing from the spirit and scope thereof.

FIG. 18 depicts an example implementation 1800 showing an exploded view of a self-cleaning electrical contact 1802 that is formed as part of the mechanical coupling protrusions 208, 210. As previously described, the magnetic coupling devices 204, 206 of the connection portion 202 are configured to aid in forming a physical connection between the input device 104 and the computing device 102 that is manually removable by one or more hands of a user.

Magnetic fields of the magnetic coupling devices 204, 206, for instance, may work in conjunction with magnetic fields of magnets disposed in the cavity of the computing device 102 to pull the connection portion into alignment such that the mechanical coupling protrusions 208, 210 find the corresponding cavities 1402 of FIG. 14 in the slot of the computing device 102. The mechanical coupling protrusions 208, 210 may also help in formation of the physical connection by restricting removal due to mechanical binding as previously described and thereby counteract the mechanical advantage created through use of the input device 104 as a lever.

The mechanical coupling protrusions 208, 210 are also illustrated as including electrical contacts 1802. The electrical contacts 1802 in this and the following examples are configured to be self-cleaning such that a layer of oxide that forms on the contact may be removed. In this way, the electrical contact 1802 may support transfer of a larger amount of power or data than conventional techniques, e.g., approximately four or more amps as opposed to one-half amp transfers in conventional techniques. Further discussion of the self-cleaning functionality, e.g., through use of a wiping motion, may be found beginning in relation to FIG. 21. As before, although this and other examples show the mechanical coupling protrusions 208, 210 as being disposed on the input device 104 and the cavity 1402 and channel disposed on the computing device 102, this arrangement may be reversed without departing from the spirit and scope thereof, examples of which are described in relation to FIG. 27.

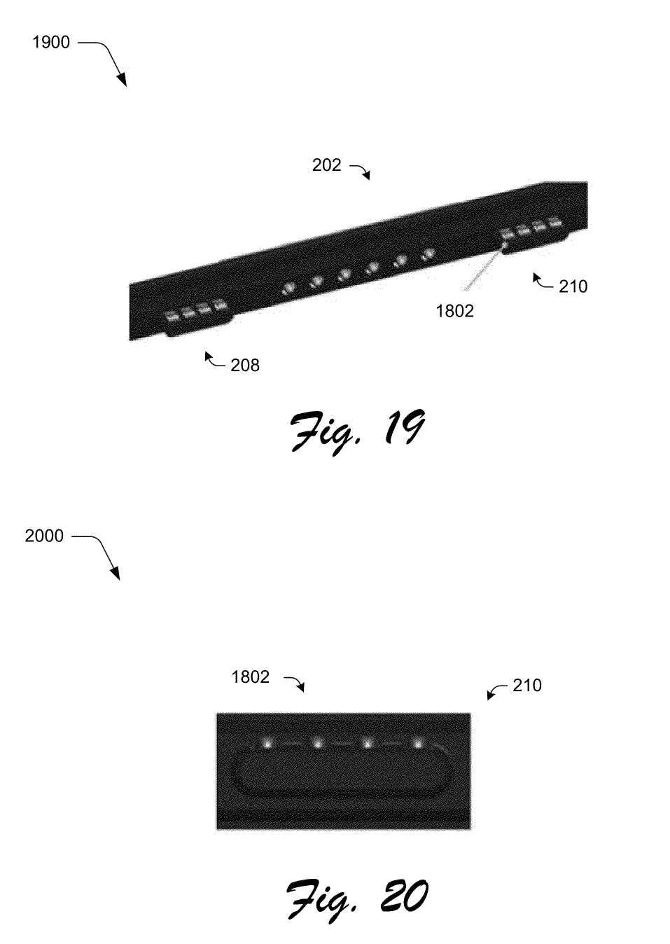

FIG. 19 depicts an example implementation 1900 showing the mechanical coupling protrusion 210 of FIG. 18 in an isometric cutaway view. FIG. 20 depicts an example implementation 2000 showing a top view of one of the mechanical coupling protrusions 210 and formed electrical contacts 1802 disposed thereon. In these examples 1900, 2000, the electrical contact 1802 is disposed on a side of the mechanical coupling protrusion 210 to coincide with an axis of insertion and removal of the connection portion 202 to a channel of the computing device 102.

The electrical contacts 1802 of FIG. 19 are illustrated as leaf springs while the electrical contacts 1802 of FIG. 20 are shown has having a rounded and formed shape. A variety of other shapes are also contemplated without departing from the spirit and scope thereof.

Each of the mechanical coupling protrusions 208, 210 in these examples are illustrated as including four electrical contacts 1802. This may be utilized to support a variety of different functionality including redundancy such that transfer of power or data is still supported in the event of loss of one or more of the electrical contacts 1802. For example, individual electrical contacts 1802 on a mechanical coupling protrusion 208 may be redundant such that the protrusion still operates as intended, use of electrical contacts by each of the mechanical coupling protrusion 208, 210 may support desired transfer of power or communication, and so on.

The inclusion of the electrical contacts 1802 as part of the mechanical coupling protrusions 208, 210 in this manner may be utilized to support a variety of functionality. For example, molded features of a plastic housing of the connection portion 202 may be configured to precisely align the mechanical coupling protrusions 208, 210 with cavities of the channel of the computing device 102 as previously described. The electrical contact 1802 may be configured to support this alignment and thus not interfere with the physical connection of the input device 104 to the computing device 102. Also, the electrical contacts 1802 may be disposed on a side of the mechanical coupling protrusion 210 that is positioned opposite of an input surface of the input device 104, e.g., a keyboard. In this way, the contacts may be protected from contact by a user and also preserve aesthetic design goals.

FIG. 21 depicts an example implementation 2100 shown via a cross section of a mechanical interlock feature supported by the mechanical coupling protrusion 208 that includes an electrical connection between the input device 104 and computing device 102. In this example, the mechanical coupling protrusion 208 is disposed within a cavity 1402 as previously described in relation to FIG. 14 and thus may resist rotation and off-axis movements as illustrated.

The electrical contact 1802 is configured to support movement that is biased away from the protrusion 208 to contact a side of the cavity 1402 that includes an electrical contact 2102. In this way, the electrical contact 1802 is configured to be biased toward contact with the electrical contact 2101 in the side of the cavity 1402. Further, this biasing may contribute to self-cleaning functionality of the electrical contacts 1802, 2102, further discussion of which is described as follows and shown in a corresponding figure.

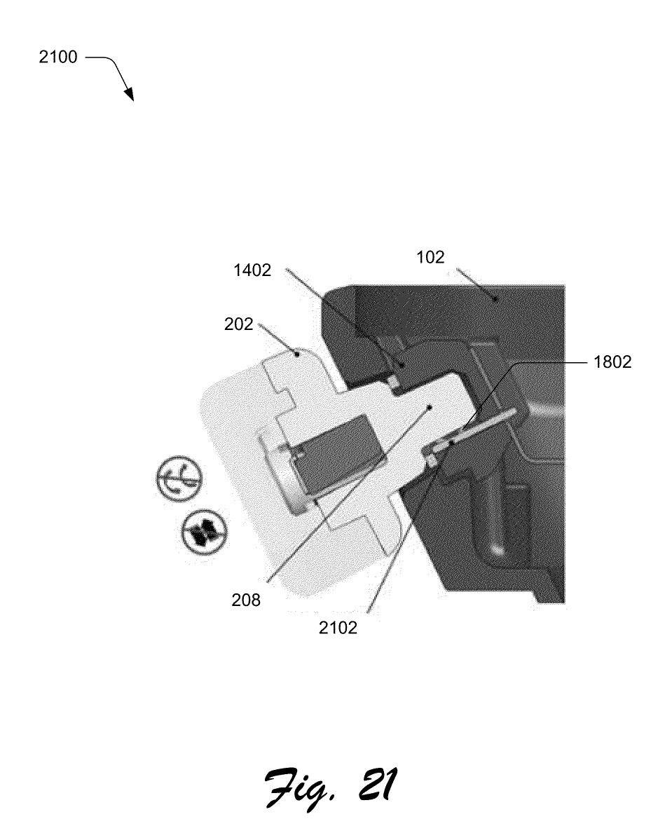

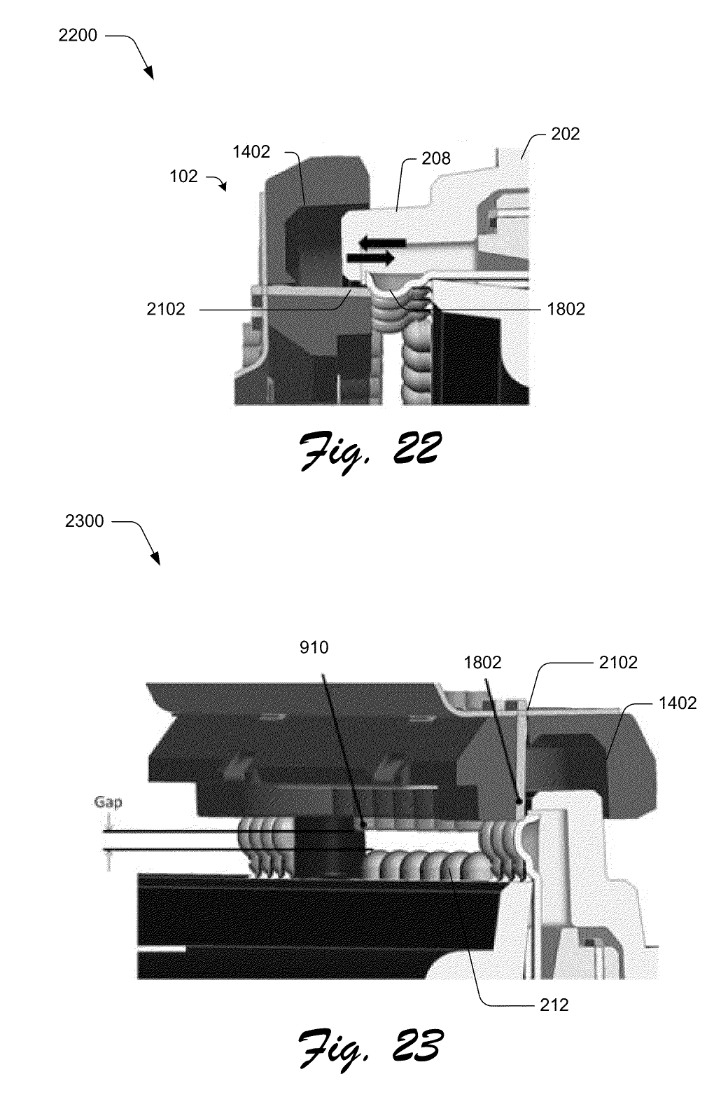

FIG. 22 depicts an example implementation 2200 showing an isometric cutaway view to exhibit self-cleaning functionality of the electrical contacts 1802, 2102 due to movement in relation to each other. Oxide layers which form on metal conductors act to raise the resistance of the electrical contacts 1802, 2102, thereby decreasing the efficiency of the connection. The energy is lost to heating, which is also not desirable for electronic components.

Accordingly, the electrical contacts 1802, 2102 are configured in this example to be self-cleaning through use of a wiping movement. For example, due to the relatively small contact surfaces and relatively high current loads (e.g., approximately 4 A per electrical contact 1802, 2102), a wiping motion may be supported because insertion and extraction movements (illustrated through the use of arrows in the FIG. 22) act to slide the two metal contact surfaces against each other and break the oxide layer. Thus, the biasing of the electrical contacts 1802, 2102 along with movement caused by insertion or removal of the mechanical coupling protrusion 208 in relation to the cavity 1402 may support self-cleaning functionality of the electrical contacts 1802, 2102 and accordingly increased data transfer and power transmission through use of these contacts.

FIG. 23 depicts an example implementation 2300 in which the input device 104 and computing device 102 are configured to support a non-arcing connection. In this example, the electrical contacts 1802 are positioned such that a connection is made between these contacts and the electrical contacts 2102 in the cavity 1402 before a connection is made between the communication contacts 212, 910. This ensures that there will not be power present during the time of connect or disconnect, as the data connection regulates the flow of power between the input device 104 and the computing device 102 in this example.

This is achieved by staggering the communication contacts 212, 910 and electrical contacts 1802, 2102 of the mechanical coupling protrusions 208, 210 (e.g., the gap may be approximately 0.5 mm) along the axis of insertion and removal. Other examples are also contemplated such that a connection supporting power is made before a connection supporting data transfer between the computing device 102 and the input device 104.

The design allows for several techniques of manufacturing assembly. As shown in an exploded isometric view 2400 of FIG. 24, the electrical contacts 1802 press onto a plastic carrier 2402 which is then pressed into a plastic housing 2404. Afterward, wires or a flexible printed circuit (FPC) may be attached. Similarly, carrier 2406 and plastic carrier 2402 may be formed as a single integral unit. Further, after the electrical contacts 1802 and communication contacts 212 are assembled, a FPC may be attached prior to insertion into the plastic housing 2404. Other permutations and combinations of the shown parts can be appreciated by one of ordinary skill in the art and are otherwise self-evident.

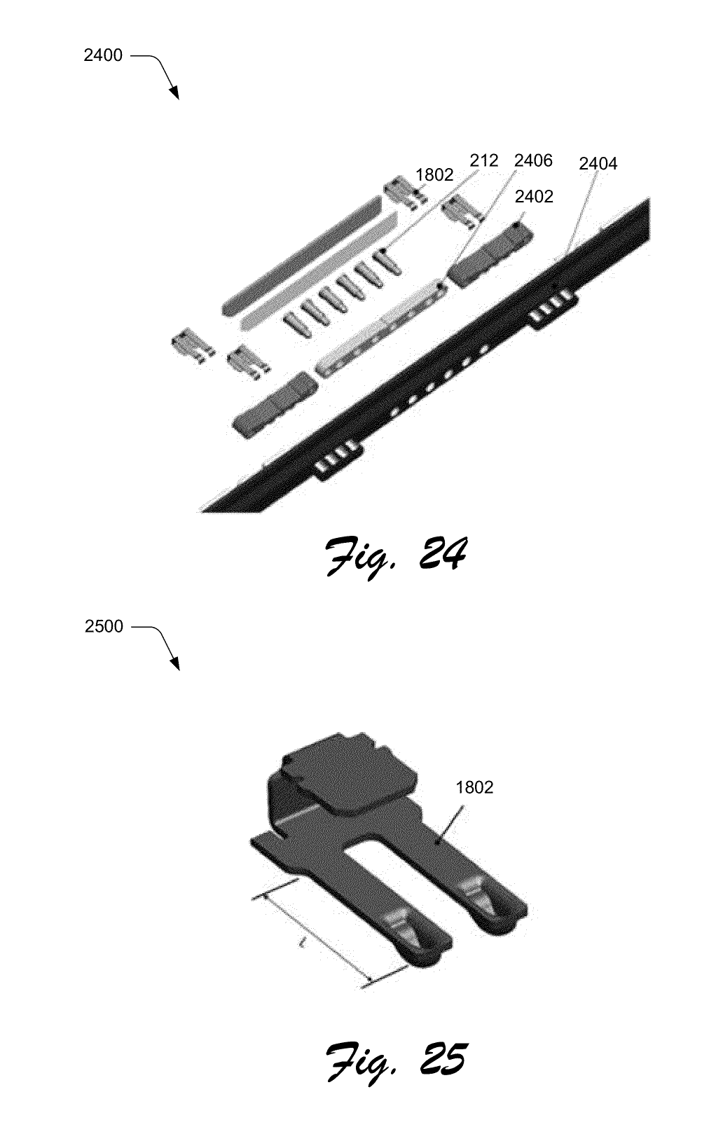

FIG. 25 depicts an example implementation 2500 showing the electrical contact 1802 of FIG. 24 in greater detail. The electrical contact 1802 in this example is configured to support a high number of cycles involving insertion and removal, e.g., at least ten thousand times. Further, each of the electrical contacts 1802, 2102 in this example is configured to transfer at least 4.5 A of current without an appreciable rise in temperature. Changes may be made to the electrical contact such as plating material, base material, material thickness, spring deflection, spring length (L), physical shape, beam cross-section, surface finish, surface coating, and so on as desired to increase and/or decrease an amount of power or communications that may be supported by the contact.

FIG. 26 depicts an example implementation 2600 in which the electrical contacts 1802 are formed to have a rounded shape. As illustrated, the electrical contact 1802 is rounded and has a base this is formed as flush to a housing of the mechanical coupling protrusion 208 to prevent inadvertent snagging of the electrical contact 1802.

The tight spacing between the electrical contact 1802 and the housing of the mechanical coupling protrusion 208 may also help to prevent plastic deformation of the electrical contact in the event of side loading. Furthermore, the housing of the mechanical coupling protrusion 208 may act to prevent the electrical contact 1802 from deforming greater than the distance “d” as illustrated. Deformation beyond the distance “d,” for instance, may lead to permanent contact deformation and reduce or eliminate the electrical contact interference utilized for conduction.

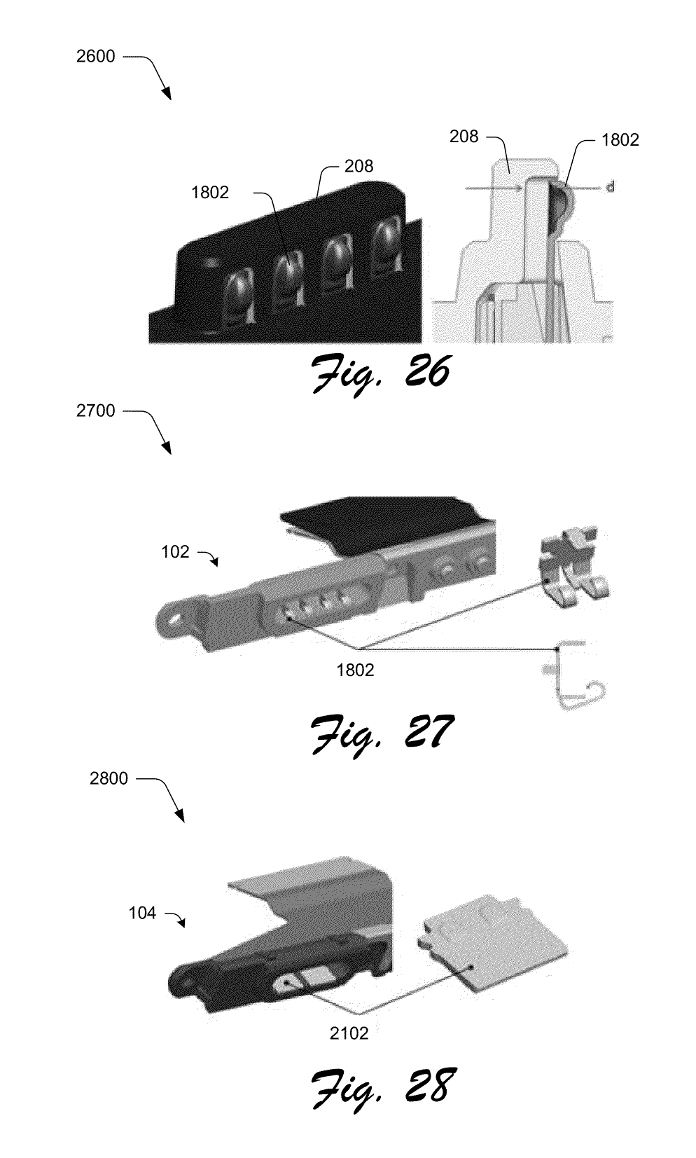

FIGS. 27 and 28 depict example implementations 2700, 2800 of alternative design combinations in which the electrical contacts 1802 are included on the computing device 102 and electrical contacts 2102 are included on the input device 104. As illustrated, the electrical contact 2102 on the input device 104 is stationary, or fixed, and is not compliant. On the other hand, the electrical contact 1802 on the computing device 102 is configured to move and is biased through use of a spring-like movement. Further, it should be noted that a cavity is formed as part of the computing device 102 and mechanical coupling protrusion is formed as part of the input device 104, however this design may also be reversed without departing from the spirit and scope thereof.

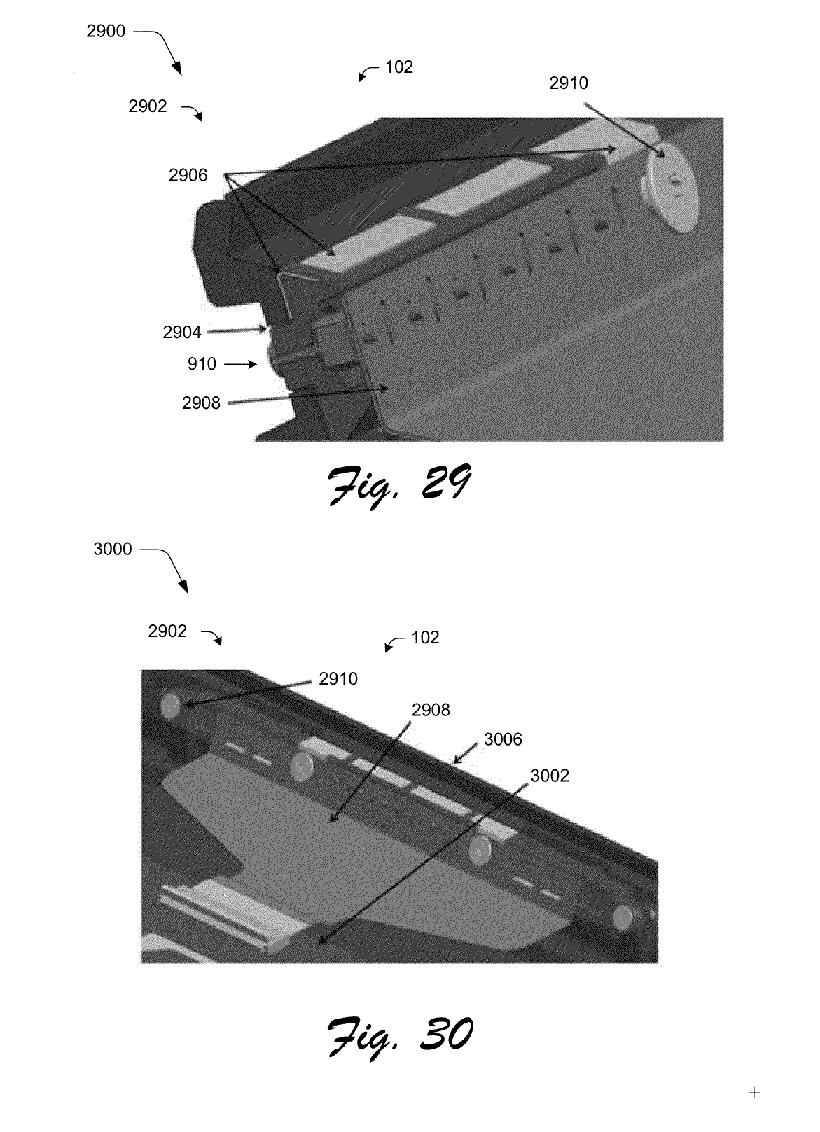

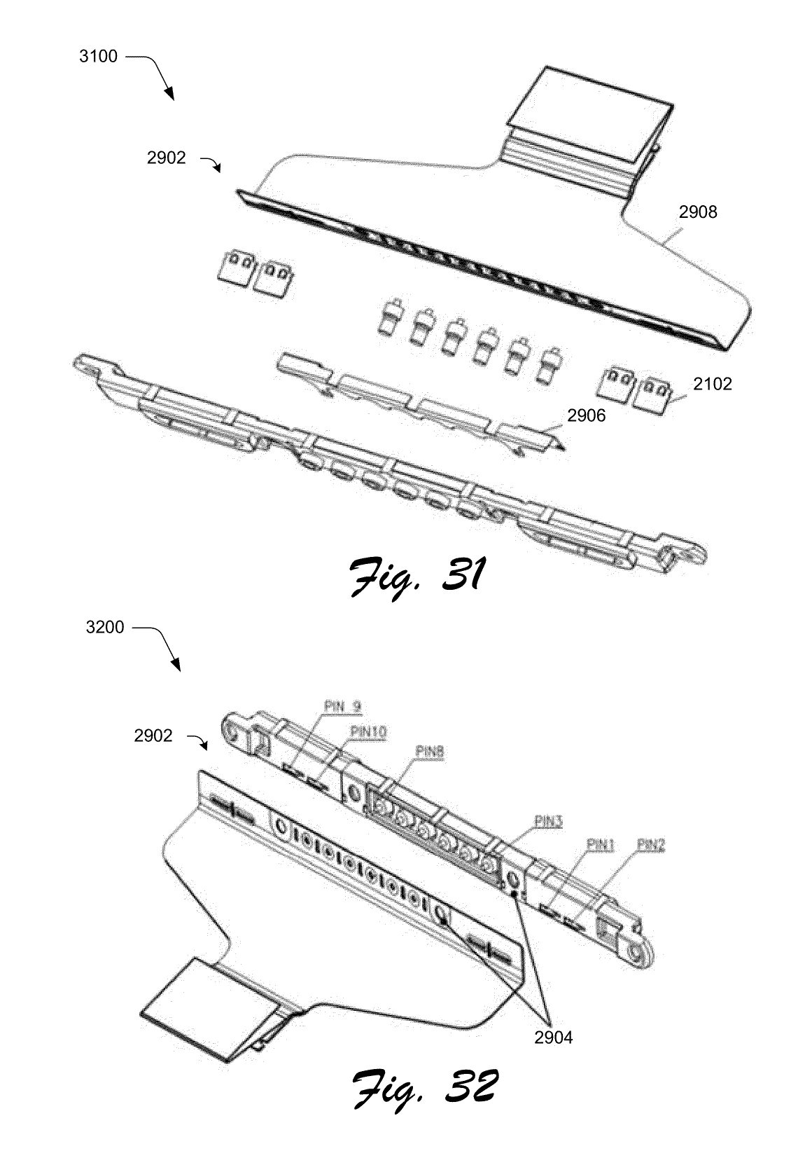

FIGS. 29 and 30 depict example implementations 2900, 3000 of an electrostatic discharge device 2902 that is configured to protect communication contacts 910 of a computing device 102. Electrostatic discharge may have an adverse effect on components of a computing device 102, such as integrated circuits, memory devices, processors, and so on. For example, communication contacts 910, while providing a pathway for data to be transferred to components of the computing device 102 may also provide a similar pathway for electrostatic discharge to also reach these components.

Accordingly, an electrostatic discharge device 2902 may be configured to provide a pathway 2904 for an electrostatic discharge to be grounded without reaching the components of the computing device 102. For example, the electrostatic discharge device 2902 may include a metal contact 2906 (e.g., formed as a sheet metal or other metal configuration) disposed near the communication contacts 910 of the computing device.

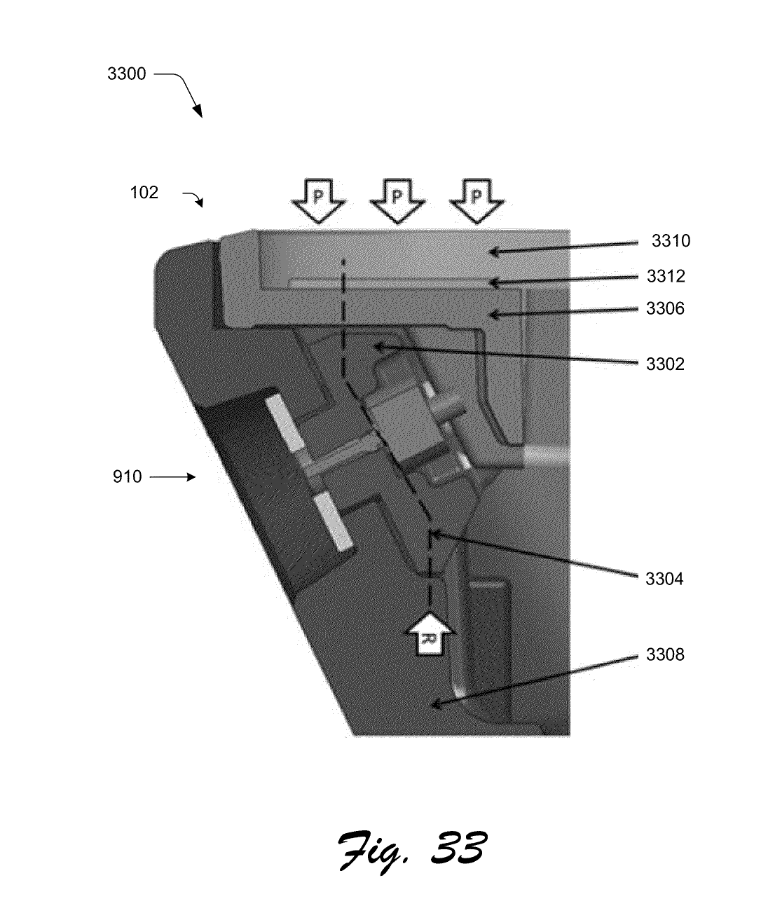

The metal contact 2906 may be electrically coupled to a plate 2906 (which may also be configured using one or more wires) via an electrical coupling device configured as a screw 2910 in this example. The plate 2908 may also be coupled to a printed circuit board 3002 of the computing device 102 to provide a ground. In this way, a static charge that may be built up on a user's body may be dissipated through use of the pathway 2904 provided by the electrostatic discharge device 2902, thereby avoiding potential damage to components of the computing device 102. FIGS. 31 and 32 include exploded views 3100, 3200 of components of the electrostatic discharge device 2902. In FIG. 32 pins 1, 2, 9, and 10 include the electrical contacts 2102 and pins 3-8 are configured as the communication contacts 910.

FIG. 33 depicts an example implementation 3300 in which a connector utilized to support communication contacts 910 of the computing device 102 acts as a structural support. A connector 3302 that is utilized to retain the communication contacts 910 (and also usable for the electrical contacts 2102) is configured in this instance to create a direct load path 3304 between a bezel 3306 of a display module and a housing 3308 of the computing device 102.

Consequently, this allows for a continuous bonding perimeter between glass 3310 and an adhesive 3312 that is utilized to bond the class to the glass bezel 3306. This also provides a continuous perimeter between the bezel 3306 of the display module and the housing 3308 that would otherwise be interrupted due to inclusion of the communication contacts 910 due to space constraints.

Example System and Device

FIG. 34 illustrates an example system generally at 3400 that includes an example computing device 3402 that is representative of one or more computing systems and/or devices that may implement the various techniques described herein. The computing device 3402 may be, for example, be configured to assume a mobile configuration through use of a housing formed and size to be grasped and carried by one or more hands of a user, illustrated examples of which include a mobile phone, mobile game and music device, and tablet computer although other examples are also contemplated.

The example computing device 3402 as illustrated includes a processing system 3404, one or more computer-readable media 3406, and one or more I/O interface 3408 that are communicatively coupled, one to another. Although not shown, the computing device 3402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 3404 is representative of functionality to perform one or more operations using hardware. Accordingly, the processing system 3404 is illustrated as including hardware element 3410 that may be configured as processors, functional blocks, and so forth. This may include implementation in hardware as an application specific integrated circuit or other logic device formed using one or more semiconductors. The hardware elements 3410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 3406 is illustrated as including memory/storage 3412. The memory/storage 3412 represents memory/storage capacity associated with one or more computer-readable media. The memory/storage component 3412 may include volatile media (such as random access memory (RAM)) and/or nonvolatile media (such as read only memory (ROM), Flash memory, optical disks, magnetic disks, and so forth). The memory/storage component 3412 may include fixed media (e.g., RAM, ROM, a fixed hard drive, and so on) as well as removable media (e.g., Flash memory, a removable hard drive, an optical disc, and so forth). The computer-readable media 3406 may be configured in a variety of other ways as further described below.

Input/output interface(s) 3408 are representative of functionality to allow a user to enter commands and information to computing device 3402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 3402 may be configured in a variety of ways to support user interaction.

The computing device 3402 is further illustrated as being communicatively and physically coupled to an input device 3414 that is physically and communicatively removable from the computing device 3402. In this way, a variety of different input devices may be coupled to the computing device 3402 having a wide variety of configurations to support a wide variety of functionality. In this example, the input device 3414 includes one or more keys 3416, which may be configured as pressure sensitive keys, mechanically switched keys, and so forth.

The input device 3414 is further illustrated as include one or more modules 3418 that may be configured to support a variety of functionality. The one or more modules 3418, for instance, may be configured to process analog and/or digital signals received from the keys 3416 to determine whether a keystroke was intended, determine whether an input is indicative of resting pressure, support authentication of the input device 3414 for operation with the computing device 3402, and so on.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 3402. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 3402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 3410 and computer-readable media 3406 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 3410. The computing device 3402 may be configured to implement particular instructions and/or functions corresponding to the software and/or hardware modules. Accordingly, implementation of a module that is executable by the computing device 3402 as software may be achieved at least partially in hardware, e.g., through use of computer-readable storage media and/or hardware elements 3410 of the processing system 3404. The instructions and/or functions may be executable/operable by one or more articles of manufacture (for example, one or more computing devices 3402 and/or processing systems 3404) to implement techniques, modules, and examples described herein.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. An input device comprising:
an input portion configured to generate signals to be processed by a computing device; and
a connection portion attached to the input portion using a flexible hinge, the connection portion configured to be communicatively coupled to the computing device to communicate the generated signals and physically coupled to the computing device using:
a projection that is configured to be disposed within a channel formed in a housing of the computing device; and
a protrusion disposed on the projection, the protrusion configured to be received within a cavity formed as part of the channel, the protrusion including an electrical contact that is configured to be self-cleaning due to movement of the protrusion in relation to the cavity and is configured to transfer power between the input device and the computing device.

2. An input device as described in claim 1, wherein the electrical contact is configured to be self-cleaning due to a wiping motion that is sufficient to remove at least part of an oxide disposed on the electrical contact through movement against at least part of the computing device.

3. An input device as described in claim 1, wherein the electrical contact is configured to be biased to contact an edge of the cavity thereby supporting a wiping motion to perform the self-cleaning and ability to transfer power between the input device and the computing device.

4. An input device as described in claim 1, wherein the protrusion includes a plurality of said electrical contacts.

5. An input device as described in claim 4, wherein at least a portion of the plurality of said electrical contacts are configured to transmit more than 1 amp of electricity.

6. An input device as described in claim 1, wherein the protrusion is configured to be removed from the cavity along an axis defined by a height of the protrusion from the projection and that coincides with the wiping motion and to resist movement along at least one different axis.

7. An input device as described in claim 6, wherein the protrusion is configured to mechanically bind within the cavity in order to resist the movement along the at least one different axis.

8. An input device as described in claim 1, wherein the connection portion further configured to form the physical connection through use of magnetism.

9. An input device as described in claim 8, wherein the magnetism is supported through use of a magnetic coupling device that is disposed on the connection portion or the computing device.

10. An input device as described in claim 1, wherein the connection portion further includes a plurality of communication contacts that are configured to contact contacts disposed within the channel of the computing device to provide the communicative coupling.

11. An input device as described in claim 10, wherein connection portion is configured to form an electrical connection to support the transfer of power using the electrical contact before communicative coupling is formed using the plurality of communication contacts as part of connection of the input device to the computing device.

12. A computing system comprising:
a computing device and an input device that are configured to be physically and communicatively coupled using:
a projection that is configured to be disposed within a channel;
communication contacts that are configured to contact contacts within the channel to support the communicative coupling; and
a protrusion disposed on the projection, the protrusion configured to be received within a cavity formed as part of the channel, the protrusion including an electrical contact that is configured to engage in a wiping motion when the protrusion is moved within the cavity and transfer power between the input device and the computing device.

13. A computing system as described in claim 12, wherein the computing device and the input device are configured to support the physical coupling using magnetism.

14. A computing system as described in claim 12, wherein the wiping motion is sufficient to remove at least part of an oxide disposed on the electrical contact through movement against at least part of the computing device.

15. A computing system as described in claim 12, wherein the electrical contact is configured to be biased to contact an edge of the cavity thereby supporting the wiping motion and ability to transfer power between the input device and the computing device.

16. A computing system as described in claim 12, wherein the protrusion is configured to be removed from the cavity along an axis defined by a height of the protrusion from the projection and that coincides with the wiping motion and to resist movement along at least one different axis.

17. A computing system comprising:
a computing device and an input device that are configured to be physically and communicatively coupled using:
a projection that is configured to be disposed within a channel;
communication contacts disposed on the projection that are configured to provide the communicative coupling with contacts within the channel; and
an electrostatic discharge device configured to protect the communication contacts from an electrostatic discharge by providing a path from the projection to ground the electrostatic discharge.

18. A computing system as described in claim 17, wherein the electrostatic discharge device includes a contact area that forms part of a perimeter around at communication contacts.

19. A computing system as described in claim 17, further comprising a magnetic coupling device configured to support the physical coupling of the computing device to the input device.

20. A computing system as described in claim 17, further comprising a protrusion disposed on the projection, the protrusion configured to be received within a cavity formed as part of the channel, the protrusion including an electrical contact that is configured to engage in a wiping motion when the protrusion is moved within the cavity and transfer power between the input device and the computing device
